(19) United States
(12) Patent Application Publication
(10) Pub. No.: US 2013/0097034 A1
(43) Pub. Date: Apr. 18, 2013

(54) Systems and Methods for Facilitating Point of Sale Transactions

(71) Applicant: FIRST DATA CORPORATION, Greenwood Village, CO (US)

(72) Inventors: Vijay Kumar Royyuru, Norristown, PA (US); Dominic John Morea, Marietta, GA (US)

(73) Assignee: FIRST DATA CORPORATION, Greenwood Village, CO (US)

(21) Appl. No.: 13/650,671

(22) Filed: Oct. 12, 2012

Related U.S. Application Data
(60) Provisional application No. 61/546,247, filed on Oct. 12, 2011.

(51) Int. Cl. G06K 19/06; G06Q 20/20

(52) U.S. Cl. 705/17; 235/494

(57) ABSTRACT

In yet another embodiment, a computer-implemented method can be provided. The method can include storing, in at least one memory associated with a mobile device, payment information. The method can further include generating, utilizing the payment information, a displayable image. Furthermore, the method can include directing output of the image by a display associated with the mobile device, wherein the image is scanned by a reader device at a point of sale in order to complete a point of sale transaction.

### RELATED APPLICATION

This application claims priority to U.S. Ser. No. 61/546,247, titled “Systems and Methods for Facilitating Point of Sale Transactions,” filed on Oct. 12, 2011, the contents of which are incorporated herein by reference.

### FIELD OF THE DISCLOSURE

Embodiments of the disclosure relate generally to point of sale transactions, and more specifically to the communication between a merchant point of sale device and a consumer device during a point of sale transaction.

### BACKGROUND OF THE DISCLOSURE

A purchase transaction at a point of sale (“POS”) typically involves the provision of payment information from a consumer payment device to a merchant terminal. For example, a consumer payment card is typically swiped by a merchant in order to read magnetic stripe information from the card. Increasingly, a wide variety of other types of consumer devices are being utilized in association with POS payment transactions. For example, a consumer can utilize a contactless smart card or a near field communication (“NFC”) mobile device to provide payment information to a merchant terminal.

However, merchant POS terminals may not be equipped with NFC, radio frequency (“RF”), or other contactless reader devices. Additionally, in some instances, a merchant may be unable to or may have difficulty deploying a contactless reader. In these situations, a consumer utilizing a contactless-enabled mobile device or other contactless device may have difficulty completing a payment transaction. Accordingly, there is an opportunity for improved system and methods for communicating transaction-related information between a consumer device and a merchant device.

### SUMMARY

Certain embodiments of the disclosure can address some or all of the above needs. Certain embodiments of the disclosure can provide systems and methods for facilitating point of sale transactions. In one embodiment, one or more computer-readable media can be provided. The one or more computer-readable media can be configured to store computer-executable instructions. When executed by one or more processors, the computer-executable instructions can configure the one or more processors to store, in at least one memory associated with a mobile device, payment information. In addition, the computer-executable instructions can configure the one or more processors to generate, utilizing the payment information, a displayable image. Further, the computer-executable instructions can configure the one or more processors to direct output of the image by a display associated with the mobile device, wherein the image is scanned by a reader device at a point of sale in order to complete a point of sale transaction.

In one aspect of an embodiment, the payment information can be stored on a secure element associated with the mobile device.

In one aspect of an embodiment, the payment information can include a payment account number.

In one aspect of an embodiment, the displayable image can include one of (i) a barcode image or (ii) a quick response code image.

In one aspect of an embodiment, the computer-executable instructions can further configure the one or more processors to receive, via a wallet application, a user instruction to generate the displayable image; and access, by the wallet application in response to the user instruction, the stored payment information in order to generate the displayable image.

In another embodiment, a merchant point of sale device can be provided. The merchant point of sale device can include at least one reader device configured to scan an image displayed by a mobile device utilized by a consumer at a point of sale, wherein the image can include payment information. In addition, the merchant point of sale device can include at least one processor configured to (i) receive information associated the scanned image, (ii) process the received information in order to extract the payment information, and (iii) process a payment transaction utilizing the payment information.

In one aspect of an embodiment, the at least one reader device can include an optical scanner.

In one aspect of an embodiment, the scanned image can include one of (i) a barcode image or (ii) a quick response code image.

In one aspect of an embodiment, the payment information can include a payment account number.

In yet another embodiment, a computer-implemented method can be provided. The method can include storing, in at least one memory associated with a mobile device, payment information. The method can further include generating, utilizing the payment information, a displayable image. Furthermore, the method can include directing output of the image by a display associated with the mobile device, wherein the image is scanned by a reader device at a point of sale in order to complete a point of sale transaction.

In one aspect of an embodiment, the payment information can be stored on a secure element associated with the mobile device.

In one aspect of an embodiment, the payment information can include a payment account number.

In one aspect of an embodiment, the displayable image can include one of (i) a barcode image or (ii) a quick response code image.

In one aspect of an embodiment, the method can further include receiving, via a wallet application, a user instruction to generate the displayable image; and accessing, by the wallet application in response to the user instruction, the stored payment information in order to generate the displayable image.

### BRIEF DESCRIPTION OF THE FIGURES

FIG. 1 illustrates a block diagram of an example system that may be utilized in accordance with various embodiments of the disclosure.

FIG. 2 illustrates a flow diagram of an example process for communicating payment information from a consumer device to a merchant terminal, according to an example embodiment of the disclosure.

FIG. 3 illustrates a flow diagram of another example process for communicating payment information from a consumer device to a merchant terminal, according to an example embodiment of the disclosure.

### DETAILED DESCRIPTION OF THE DISCLOSURE

Various embodiments of the disclosure are directed to systems and methods for facilitating communication between a merchant device, such as a merchant point of sale (“POS”) device, and a consumer device (e.g., a mobile device, a contactless payment device, etc.). In one example embodiment, payment information, such as payment account information (e.g., track one and/or track two payment account data, value added services (“VAS”) information, etc.) may be stored on the consumer device. As desired, the payment information may be stored in a relatively secure manner. For example, the payment information may be stored on one or more secure elements. At a point of sale, at least a portion of the payment information may be accessed and utilized to generate one or more displayable images, such as one or more barcode images and/or quick response codes. The generated image(s) may then be output by one or more suitable displays associated with the consumer device.

One or more suitable reader devices associated with the merchant POS device, such as an optical scanner and/or a barcode scanner, may be utilized to scan, capture, or read the displayed image(s). The scanned or captured information may then be processed by the merchant POS device in order to extract the payment information. The POS device may then utilize at least a portion of the payment information to request and/or complete a transaction, such as a payment transaction.

In certain embodiments, the consumer device may be a consumer device that is configured to facilitate contactless payment transactions, such as near field communication (“NFC”) or radio frequency (“RF”) transactions. However, the merchant POS device may be a device that is not configured to facilitate contactless transactions. Accordingly, a displayable image may be generated by the consumer device, and the displayable image may be scanned or otherwise read by the POS device.

Embodiments of the disclosure now will be described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

System Overview

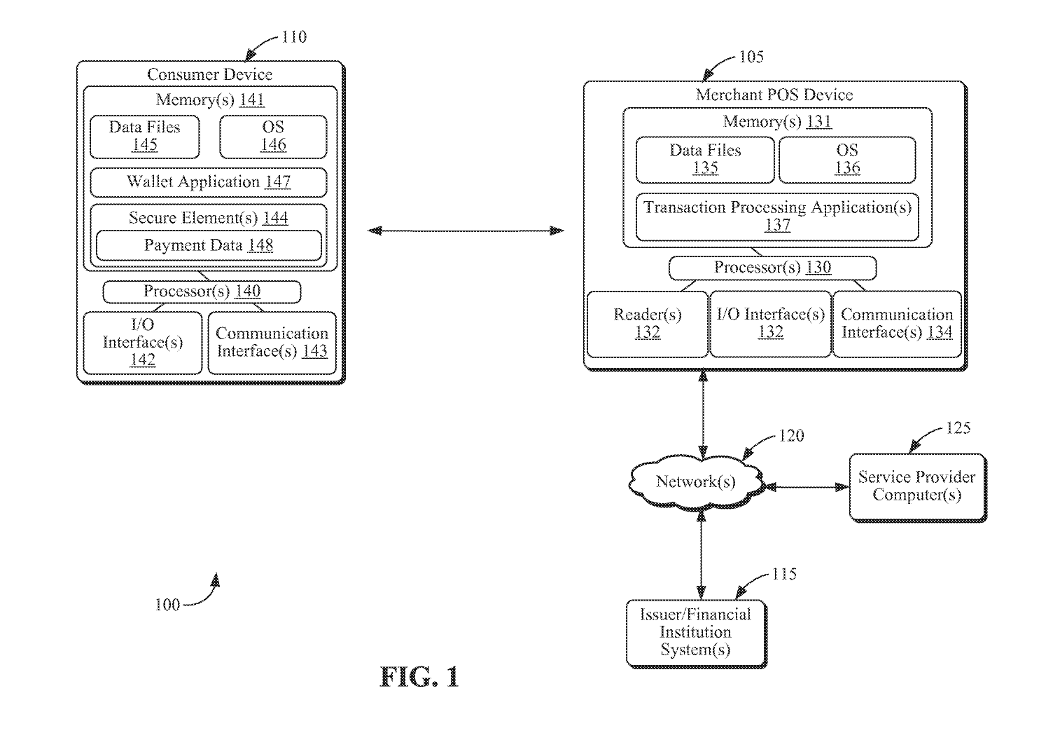

FIG. 1 represents a block diagram of an example system 100 for facilitating communication between a consumer device and a point of sale device, according to one embodiment of the disclosure. In certain embodiments, the system 100 may facilitate the collection of transaction-related information from a consumer device at a point of sale. As shown in FIG. 1, the system 100 may include one or more merchant POS devices 105 (e.g., merchant POS terminals, merchant registers, merchant computers, etc.) and/or one or more consumer devices 110. As desired, the system 100 may include a wide variety of other entities associated with payment transactions, such as one or more payment account issuer systems and/or computers 115 in communication with the merchant POS devices 105 via any number of suitable networks 120 and/or communication channels. Additionally, in certain embodiments, the system 100 may include one or more service provider computers 125 in communication with the merchant POS devices 105 via the networks 120.

With reference to FIG. 1, any number of merchant POS devices may be provided. A merchant POS device 105 may be a suitable device that facilitates the completion of payment transactions. In operation, the merchant POS device 105 may utilize one or more processors 130 to execute computer-readable instructions that facilitate the collection of transaction-related information (e.g., information associated with items to be purchased, transaction amounts, consumer payment account information, VAS information, etc.) and/or the generation and/or output of transaction-related requests (e.g., transaction authorization requests, value added service (“VAS”) requests, etc.). As a result of executing these computer-readable instructions, a special purpose computer or particular machine may be formed that facilitates the completion of POS payment transactions.

In addition to having one or more processors 130, the merchant POS device 105 may further include and/or be associated with one or more memory devices 131, readers 132 or reader devices, input/output (“I/O”) interface(s) 133, and/or network interface(s) 134. The memory 131 may be any computer-readable medium, coupled to the processor(s) 130, such as random access memory (“RAM”), read-only memory (“ROM”), and/or removable storage devices. The memory 131 may store a wide variety of data files 135 and/or various program modules, such as an operating system (“OS”) 136 and/or one or more transaction processing applications or modules 137. The data files 135 may include any suitable data that facilitates the operation of the merchant POS device 105 and/or interaction of the merchant POS device 105 with one or more other components (e.g., one or more issuer systems 115, one or more service provider computers 125, etc.) of the system 100. For example, the data files 135 may include information associated with the readers 132, information that facilitates the processing of images, acquiring platform information, service provider information, information associated with the generation of proposed transaction and/or VAS requests, information associated with available VAS, and/or routing information for proposed transactions.

The OS 136 may be suitable module that facilitates the general operation of the merchant POS device 105, as well as the execution of other program modules. For example, the OS 136 may be, but is not limited to, Microsoft Windows®, Apple OSX™, Unix, a mainframe computer operating system (e.g., IBM z/OS, MVS, OS/390, etc.), or a specially designed operating system. The transaction processing applications or modules 137 may include any number of suitable software modules and/or applications that facilitate the receipt of transaction information (e.g., purchase transaction information, a purchase amount, information associated with purchased products, etc.), the receipt of payment account information read from a consumer device (e.g., information read from one or more displayable images), the generation of a proposed transaction, and/or the output of the proposed transaction. In certain embodiments, the transaction processing applications 137 may additionally facilitate the identification of information associated with a wide variety of value added services and the generation of one or more requests to invoke value added services, such as requests communicated to one or more service provider computers 125.

According to an aspect of the disclosure, the transaction processing application 137 may be configured to receive information from the one or more readers and process the received information in association with a payment transaction. For example, the transaction processing application 137 may receive information associated with one or more scanned barcodes and/or scanned QR codes. The transaction processing application 137 may then process the received information in order to extract and/or otherwise determine payment information included in the received information. For example, the transaction processing application 137 may extract payment account information, such as track one and/or track two data stored on a consumer device 110.

In certain embodiments, the transaction processing application 137 may identify a wide variety of transaction information and utilize at least a portion of the transaction information to provide any number of transaction-related services. For example, the transaction processing application 137 may identify information associated with products and/or services to be purchased, as well as payment account information (e.g., information extracted from one or more images, etc.) and/or other transaction-related information (e.g., coupon information, etc.). As desired, the transaction processing application 137 may invoke and/or request (e.g., request a service provider computer, etc.) the invocation of a wide variety of VAS associated with a transaction, such as the application of coupons, the award and/or redemption of loyalty rewards, etc. The transaction processing application 137 may then generate a proposed transaction request that is output for routing and/or delivery to a suitable transaction processor, such as a payment account issuer system 115. In the event that the transaction is authorized, the transaction processing application 137 may invoke and/or request the invocation of a wide variety of VAS following the transaction, such as receipt generation and/or delivery services, product registration services, etc. Indeed, a wide variety of suitable operations may be performed by the transaction processing application 137.

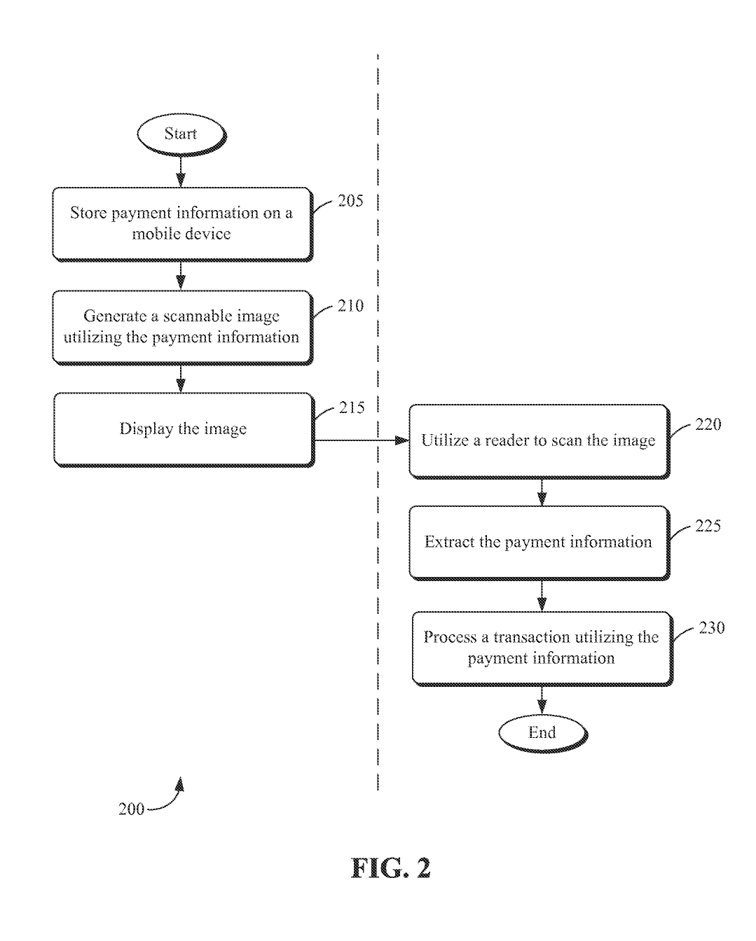

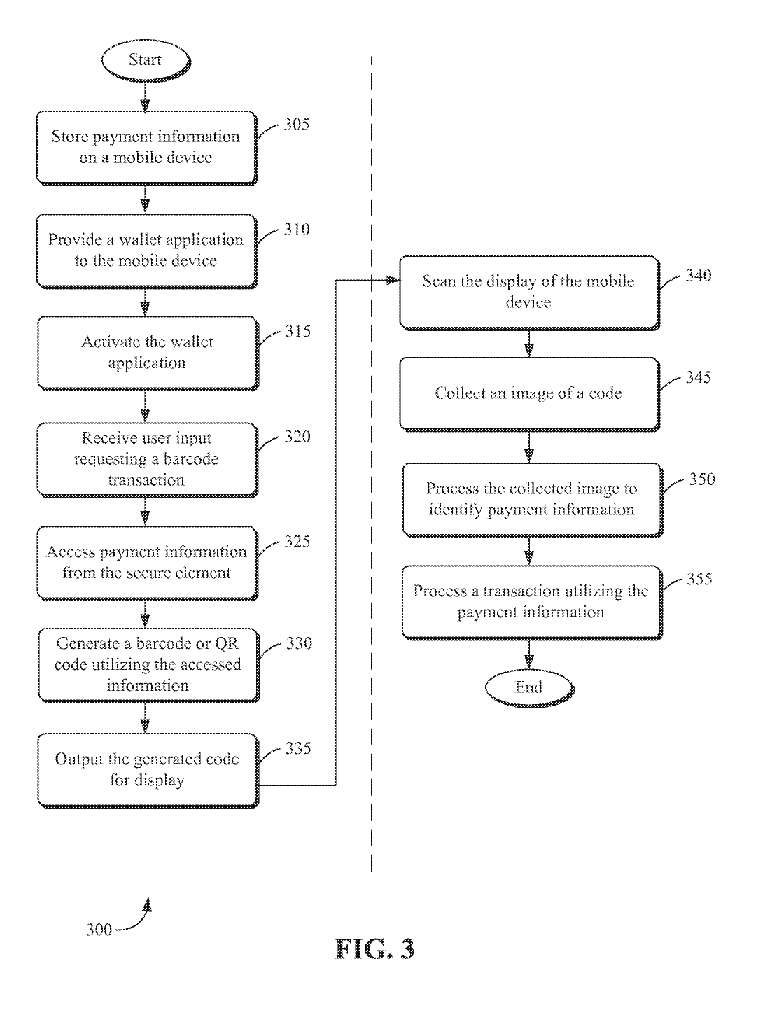

A few examples of the operations that may be performed by a transaction processing application 137 and/or the merchant POS device 105 are described in greater detail below with reference to FIGS. 2 and 3.

With continued reference to the merchant POS device 105, any number of suitable reader devices 132 may be provided. Example readers include optical readers, barcode readers, and/or other suitable reader devices. Each reader 132 may be configured to scan one or more images displayed by a consumer device 110. For example, a reader 132 may be configured to scan a barcode and/or a QR code displayed by the consumer device 110. In this regard, information associated with one or more displayed images may be collected, and at least a portion of the collected information may be provided to the processors 130 for evaluation and/or processing. In certain embodiments, a reader 132 may be utilized in association with a merchant POS device 105 when the merchant POS device 105 is not equipped with one or more contactless readers. In other embodiments, the merchant POS device 105 may additionally include other types of reader modules and associated reader applications, such as a NFC reader, a RF reader, a Bluetooth reader, or a Wi-Fi reader.

The one or more I/O interfaces 133 may facilitate communication between the merchant POS device 105 and one or more input/output devices; for example, one or more user interface devices, such as a display, a keypad, a mouse, a pointing device, a control panel, a touch screen display, a remote control, a microphone, a speaker, the reader devices 132, etc., that facilitate user interaction with the merchant POS device 105. The one or more network and/or communication interfaces 134 may facilitate connection of the merchant POS device 105 to one or more suitable networks and/or communication links. In this regard, the merchant POS device 105 may receive and/or communicate information to other components of the system 100, such as the issuer systems 115, the service provider computers 125, and/or other devices and/or systems.

Additionally, with continued reference to FIG. 1, any number of consumer devices 110 may be provided. Examples of suitable consumer devices 110 include, but are not limited to, mobile devices (e.g., mobile phones, smart phones, etc.) and other contactless transaction devices that include a suitable display that may be utilized to output images to be scanned or read by one or more readers 132 associated with the merchant POS device 105. According to an aspect of the disclosure, a consumer device 110 may be a suitable device that is capable of storing payment information and generating one or more displayable images from the payment information. In this regard, the payment information may be collected and processed by the merchant POS device 105. In certain embodiments, the consumer device 110 may additionally be equipped with contactless communications functionality, such as NFC, RF, and/or other functionality.

As desired, a consumer device 110 may include any number of processor-driven devices, including but not limited to, a mobile computer, an application-specific circuit, a minicomputer, a microcontroller, and/or any other processor-based device. A consumer device 110 may utilize one or more processors 140 to execute computer-readable instructions that facilitate the general operation of the consumer device 110 (e.g., call functionality, etc.) and/or the generation of displayable images to facilitate interaction with a merchant POS device 105 for payment transaction purposes. As a result of executing these computer-readable instructions, a special purpose computer or particular machine may be formed that facilitates the provision of transaction-related services on behalf of a consumer.

In addition to having one or more processors 140, the consumer device 110 may further include and/or be associated with one or more memory devices 141, input/output (“I/O”) interface(s) 142, and/or communication and/or network interface(s) 143. The memory 141 may be any computer-readable medium, coupled to the processor(s) 140, such as random access memory (“RAM”), read-only memory (“ROM”), and/or removable storage devices. The memory 141 may store a wide variety of data files 145 and/or various program modules, such as an operating system (“OS”) 146 and/or one or more wallet applications 147. In certain embodiments, a consumer device 110 may include one or more secure elements 144 configured to securely store and/or access information, such as payment applications, payment account information, and/or other transaction-related information. For example, one or more secure elements 144 may be configured to store payment data 148 or payment information, such as information that may be utilized to generate one or more displayable images. The secure elements 144 may be stored in the memory 141 and/or included as a separate component of the consumer device 110. For example, a secure element 144 may be a separate chip that is configured to communicate with primary computing functionality for the consumer device 110. As desired, one or more of the transaction applications may be stored on a secure element 144. These transaction applications may be invoked by other components of the consumer device 110, such as the wallet application 147. In other embodiments, one or more transaction applications and/or transaction-related information may be stored in a general memory of the consumer device 110.

The data files 145 may include any suitable data that facilitates the operation of the consumer device 110 and/or interaction of the consumer device 110 with one or more other components of the system 100. For example, the data files 145 may include information associated with accessing the secure elements 144, information associated with invoking a wallet application 147, information associated with invoking one or more transaction applications, and/or information that facilitates the generation of one or more displayable images. The OS 146 may be suitable module that facilitates the general operation of the consumer device 110, as well as the execution of other program modules. For example, the OS 146 may be, but is not limited to, a suitable mobile OS or a specially designed operating system. As desired, the consumer device 110 may additionally include one or more communication modules that facilitate interaction with other devices, such as merchant POS devices equipped with contactless readers and/or other communications functionality. For example, a suitable near field communication module, radio frequency module, Bluetooth module, or other suitable communication module may be included in the consumer device 110.

The wallet application 147 may include one or more suitable software modules and/or applications configured to generate or direct the generation of one or more displayable images that include payment information. Additionally, the wallet application 147 may be configured to facilitate the direction of operations associated with one or more contactless payment transactions, such as the output of payment information to be received by a contactless reader device. As desired, the wallet application 147 may invoke any number of suitable transaction applications, such as transaction applications stored on the secure elements 144. The transaction applications may be, for example, applications associated with various payment accounts and/or payment account issuers.

According to an example embodiment of the disclosure, the wallet application 147 may generate one or more suitable displays and/or graphical user interfaces that facilitate the receipt of user commands associated with payment transactions. At least one display may include an option to request a barcode or QR code payment transaction. As desired, user options may also allow a user to select a suitable payment account. Additionally, in certain embodiments, a consumer PIN or other consumer authentication mechanism may be initiated in order to verify the identity of the consumer. Based upon the receipt of a user request for a barcode or QR code transaction, the wallet application 147 may access payment information 148 associated with a payment account (e.g., a selected payment account, a default payment account, etc.). For example, the wallet application 147 may invoke a suitable transaction application associated with a desired payment account, and the wallet application 147 may collect payment information 148 from the invoked transaction application. As another example, the wallet application 147 may access stored payment information 148 from memory 141 and/or a secure element 144.

Once payment information 148 is obtained, the wallet application 147 may utilize the payment information 148 to generate one or more suitable images. Alternatively, one or more images may be accessed from memory or received from a transaction application. The wallet application 147 may then direct one or more suitable output devices (e.g., a display, a touch screen display, etc.) to display or output the one or more images. For example, the wallet application 147 may direct the output of one or more barcode images and/or QR codes that include the payment information 148. In this regard, the merchant POS device 105 may utilize one or more suitable readers 132 to scan the images in order to collect the payment information 148.

According to an aspect of the disclosure, the payment data 148 may include information associated with a payment account to be utilized in association with a payment transaction, such as a payment account number. In one example embodiment, the payment data 148 may include track one and track two data, such as the data that may be stored by a conventional magnetic stripe payment device. Additionally, in certain embodiments, the payment data 148 may include a wide variety of other transaction-related information, such as consumer identification information, consumer device identification information, coupons and/or offers to be redeemed, loyalty information (e.g., a loyalty account number, if available), electronic receipt preferences, warranty preferences, product registration preferences, etc. As desired, this transaction-related information may be utilized to generate one or more displayable images. Alternatively, the transaction-related information may be provided to a merchant POS device 105 via other available communication techniques. Additionally, in certain embodiments, the merchant POS device 105 may communicate with a service provider computer, an acquiring platform, an issuer system, and/or other devices in order to facilitate the back-end processing of a transaction (e.g., authorization, settlement, value added services, etc.). In other embodiments, the consumer device 110 and/or the wallet application 147 may communicate with one or more of these entities in conjunction with transaction processing. For example, the wallet application 147 may provide payment account information to a service provider computer rather than to the merchant POS device 105. Indeed, a wide variety of different transaction processing flows and/or methods may be utilized as desired in various embodiments.

A few examples of the operations that may be performed by the wallet application 147 and/or the consumer device 110 are described in greater detail below with reference to FIGS. 2 and 3.

The one or more I/O interfaces 142 may facilitate communication between the consumer device 110 and one or more input/output devices; for example, one or more user interface devices, such as a display, a keypad, a touch screen display, a microphone, a speaker, etc., that facilitate user interaction with the consumer device 110. The one or more network and/or communication interfaces 143 may facilitate connection of the consumer device 110 to one or more suitable networks, for example, the network(s) 120 illustrated in FIG. 1. In this regard, the consumer device 110 may receive and/or communicate information to other components of the system 100.

With continued reference to FIG. 1, any number of issuer and/or financial institution systems 115 may be provided. An issuer system 115 may facilitate the backend processing of a proposed transaction. For example, an issuer system 115 may facilitate the approval and/or settlement of a proposed transaction. In certain embodiments, a proposed transaction may be routed to an issuer system 115 via a suitable transaction network (e.g., a debit network, a credit network, etc.), and the issuer system 115 may evaluate the proposed transaction. An approval or rejection of the proposed transaction may then be output for communication to a merchant POS device 105. The issuer system 115 may then facilitate the settlement of the proposed transaction. In certain embodiments, an issuer system 115 may include similar components as those discussed above for the merchant POS device 105. For example, an issuer system 115 may include any number of processors, memories, I/O interfaces, and/or network/communication interfaces.

Additionally, any number of service provider computers 125 may be utilized as desired in various embodiments of the disclosure. A service provider computer may provide a wide variety of transaction-related and/or value added services (“VAS”) in association with transactions, such as coupon redemption services, loyalty services, location-based services, electronic receipt services, product registration services, warranty services, coupon issuance services, and/or the routing of a proposed transaction to an issuer for approval and/or settlement purposes. In certain embodiments, a service provider computer 125 may include similar components as those discussed above for the merchant POS device 105. For example, a service provider computer 125 may include any number of processors, memories, I/O interfaces, and/or network/communication interfaces.

A wide variety of suitable networks and/or communication channels 120 may be utilized in association with embodiments of the disclosure. Certain networks may facilitate communication between remote devices. For example, one or more telecommunication networks, cellular networks, wide area networks (e.g., the Internet) and/or transaction networks (e.g., branded networks (e.g., a VISA network, etc.), debit and/or PIN networks, and/or a wide variety of other suitable transaction networks) may facilitate communication between various components of the system 100. Other networks and/or channels 120, if available, may facilitate communication between consumer devices 110 and merchant POS devices 105. These networks 120 may include wireless networks, RF networks, Bluetooth-enabled networks, NFC connections, etc. Due to network connectivity, various methodologies as described herein may be practiced in the context of distributed computing environments. It will also be appreciated that the various networks may include a plurality of networks, each with devices such as gateways and routers for providing connectivity between or among networks. Additionally, instead of, or in addition to, a network, dedicated communication links may be used to connect various devices in accordance with an example embodiment.

The system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1. Accordingly, embodiments of the disclosure should not be construed as being limited to any particular operating environment, system architecture, or device configuration.

Operational Overview

FIG. 2 illustrates a flow diagram of an example process 200 for communicating payment information from a consumer device to a merchant terminal, according to an example embodiment of the disclosure. In certain embodiments, the operations of the method 200 may be performed by a suitable consumer device and merchant POS device, such as the consumer device 110 and the merchant POS device 105 illustrated in FIG. 1. The method 200 may begin at block 205.

At block 205, payment information may be stored on a mobile device (or other consumer device). For example, payment account (e.g., track one and track two data) and/or other payment information may be stored on the mobile device. As desired, other transaction-related information may also be stored, such as coupon information and/or information associated with consumer preferences for a wide variety of VAS. In certain embodiments, information may be stored by one or more suitable secure elements associated with the mobile device. Alternatively, at least a portion of the information may be stored by other memory components associated with the mobile device. Additionally, as desired, a wide variety of suitable techniques may be utilized to provide the information to the mobile device prior to storage. For example, payment information may be provisioned to the mobile device by any number of suitable service providers via a suitable over the air provisioning technique.

As mentioned above, a wide variety of different types of information may be stored by the mobile device. This information may include payment-related data and/or a wide variety of VAS data. Payment-related data may include, for example, identification information for a payment account to be utilized in association with a transaction (e.g., an account number, an identifier of an account issuer, etc.), consumer identification information that may be utilized to identify or select a payment account, and/or consumer device identification information (e.g., device identifier, a mobile telephone number, etc.) that may be utilized to identify or select a payment account. VAS data may include information associated with the provision of a wide variety of VAS in association with the transaction. These VAS may be implemented by the merchant POS device 105 and/or by any number of suitable service provider computers directly or indirectly in communication with the merchant POS device 105. A wide variety of different types of VAS may be implemented as desired in various embodiments of the disclosure, and each of the VAS may be associated with information received from the consumer device 110 and/or accessed from a suitable data source on behalf of the consumer. Examples of suitable pre-transaction VAS include, but are not limited to, electronic wallet services, loyalty services, coupon redemption services, location-based mobile services, electronic receipt services, product registration services, product warranty services, coupon and/or offer issuance services, targeted advertisement services, receipt reconciliation with issuer statement services, etc. Various VAS may be invoked prior to the completion of a transaction, during the completion of the transaction, and/or following the completion of the transaction.

An example electronic wallet service, which may alternatively be implemented as a transaction processing service, may facilitate the identification of a payment account to utilize in association with a transaction, as well as the verification of a consumer's identity. A loyalty service may identify an applicable loyalty account of the consumer, such as a loyalty account with the merchant. The loyalty service may then facilitate the issuance and/or redemption of loyalty points and/or loyalty rewards in association with the transaction. A coupon redemption service may compare products being purchased (e.g., UPCs, etc.) with available coupons (e.g., coupons identified from received transaction information, coupons stored at the service provider in association with the consumer, coupons accessed from an external data source, etc.), and the coupon redemption service may identify coupons that may be redeemed. The coupon redemption service may then facilitate the communication of applied coupons to coupon issuers, and the distribution of redeemed coupon revenue to the merchant. A location-based mobile service may perform a wide variety of suitable services based upon received location information (e.g., GPS coordinates, etc.) for a consumer device. For example, a location-based mobile service may evaluate a consumer device location based upon consumer transaction processing preferences, and the location-based service may determine whether the transaction may be completed based at least in part upon the evaluation. For example, a consumer may specify that a consumer device (e.g., a mobile device of a child) can only be used at gas stations and/or grocery stores in order to complete transactions. A location-based service may utilize GPS coordinates for the consumer device to identify a merchant for a proposed transaction, and the location-based service may determine whether a transaction can be approved for the merchant. As another example of a location-based service, a consumer may request different VA services in different states and/or geographical regions. Indeed, a wide variety of different location-based services may be provided as desired.

An example electronic receipt service may generate electronic receipts for a transaction, and the electronic receipts may be delivered to any number of recipients, such as the merchant POS device 105 and/or the consumer device 110. An example product registration service may automatic complete a product registration application on behalf of the consumer and deliver the registration application to a suitable recipient, such as a manufacturer. As desired, a consumer may specify the types of products (e.g., electronics, appliances, etc.) for which product registration services will be provided. An example product warranty service may identify and store product warranty information on behalf of the consumer. Another example product warranty service may evaluate consumer preferences in order to automatically (or upon prompting) purchase an extended warranty for a purchased product. An example coupon issuance service may identify, based upon, for example, the purchased products and/or historical purchases, one or more coupons to be issued to the consumer (e.g., coupons that may be printed on the back of or otherwise associated with a receipt). Similarly, a targeted advertisement service may identify advertisements and/or promotions to be communicated to the consumer. An example receipt reconciliation service may compare a purchase amount to a subsequently obtained issuer statement (e.g., a credit card statement, a bank statement, etc.) and identify any discrepancies. In other words, an example reconciliation service may conduct an audit of the transaction on behalf of the consumer and/or the merchant.

At block 210, at least a portion of the stored information may be accessed and utilized to generate one or more displayable and/or scannable images. Examples of suitable images that may be generated, include but are not limited to, barcode images (e.g., two dimensional barcode images, etc.) and/or QR code images. Additionally, a wide variety of information may be incorporated into or included in a generated image. For example, one or more images may include payment information (e.g., payment account information, etc.). As another example, one or more images may include information associated with VAS, such as coupon data.

At block 215, the one or more generated images may be displayed or output for display by the mobile device. For example, one or more images may be presented via one or more suitable display components of the mobile device. In this regard, one or more suitable readers associated with a merchant POS device 105 may be utilized to scan or otherwise read (e.g., optical reading, etc.) the images at block 220. The scanned or read information may then be processed at block 225 in order to extract the information included in the images. For example, payment information and, as desired, VAS information may be extracted.

At block 220, the merchant POS device 105 may process a transaction (e.g., a payment transaction, etc.) utilizing the payment information (and, as desired, the VAS information). For example, the merchant POS device 105 may generate a proposed payment transaction, and the merchant POS device 105 may communicate the proposed payment transaction to an issuer system or payment processing system via any number of suitable transaction networks. Additionally, as desired, the merchant POS device 105 may request the provision of a wide variety of suitable VAS. For example, the merchant POS device 105 may communicate any number of VAS requests to one or more suitable service provider systems.

The method 200 may end following block 230.

FIG. 3 illustrates a flow diagram of another example process 300 for communicating payment information from a consumer device to a merchant terminal, according to an example embodiment of the disclosure. In certain embodiments, the operations of the method 300 may be performed by a suitable consumer device and merchant POS device, such as the consumer device 110 and the merchant POS device 105 illustrated in FIG. 1. The method 300 may begin at block 305.

At block 305, payment information, such as payment account information, may be stored on one or more secure elements of a mobile device. In certain embodiments, the payment information may be stored in association with one or more suitable transaction applications that are stored on the secure element. As desired, the payment information and/or transaction application may be provided to the mobile device via any number of suitable techniques, such as an over the air provisioning technique. Additionally, at block 310, a suitable wallet application, such as the wallet application 147 illustrated in FIG. 1, may be provided to the mobile device. For example, a suitable over the air provisioning technique or other suitable technique may be utilized to provide a wallet application 147 to the mobile device.

At block 315, the wallet application 147 may be activated on the mobile device. For example, a user of the mobile device (e.g., a consumer) may activate the wallet application 147 in order to request a transaction at a point of sale. As desired, the wallet application 147 may request and receive authentication credentials from the consumer (e.g., a user name, a password, a personal identification number, etc.), and the wallet application 147 may evaluate the authentication credentials in order to authenticate the consumer.

Additionally, the wallet application 147 may generate and direct the output of a wide variety of different payment options for presentation to the user. In this regard, user input associated with a type of desired payment transaction and/or a desired payment account may be received and processed by the wallet application 147. For example, user input requesting a barcode (or other image-based transaction) may be received at block 320.

At block 325, the wallet application 147 may access at least a portion of the stored payment information from the secure element(s). The wallet application 147 may then utilize the accessed information to generate one or more barcode, QR code, or other images for display by the mobile device. For example, accessed payment information may be incorporated into one or more generated images. As another example, accessed VAS-related information (e.g., coupon data, etc.) may be incorporated into one or more generated images. The generated images (e.g., a generated barcode or QR code with payment information) may then be output for display at block 335.

At block 340, one or more suitable readers associated with a merchant POS device 105 may be utilized to scan or otherwise read (e.g., optical reading, etc.) the displayed images. In this regard, one or more images of displayed barcodes, QR codes, and/or other codes may be collected at block 345. The collected images may then be evaluated or otherwise processed at block 350 in order to extract the information included in the images. For example, payment information and, as desired, VAS information may be extracted.

At block 355, the merchant POS device 105 may process a transaction (e.g., a payment transaction, etc.) utilizing the payment information (and, as desired, the VAS information). For example, the merchant POS device 105 may generate a proposed payment transaction, and the merchant POS device 105 may communicate the proposed payment transaction to an issuer system or payment processing system via any number of suitable transaction networks. Additionally, as desired, the merchant POS device 105 may request the provision of a wide variety of suitable VAS. For example, the merchant POS device 105 may communicate any number of VAS requests to one or more suitable service provider systems.

The method 300 may end following block 355.

The operations described and shown in the methods 200, 300, of FIGS. 2-3 may be carried out or performed in any suitable order as desired in various embodiments of the disclosure. Additionally, in certain embodiments, at least a portion of the operations may be carried out in parallel. Furthermore, in certain embodiments, less than or more than the operations described in FIGS. 2-3 may be performed.

The disclosure is described above with reference to block and flow diagrams of systems, methods, apparatuses, and/or computer program products according to example embodiments of the disclosure. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

Various block and/or flow diagrams of systems, methods, apparatus, and/or computer program products according to example embodiments of the disclosure are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special purpose, hardware-based computer systems that perform the specified functions, elements or steps, or combinations of special purpose hardware and computer instructions.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

The claimed disclosure is:

1. One or more computer-readable media configured to store computer-executable instructions that, when executed by one or more processors, configure the one or more processors to:
store, in at least one memory associated with a mobile device, payment information;
generate, utilizing the payment information, a displayable image; and
direct output of the image by a display associated with the mobile device, wherein the image is scanned by a reader device at a point of sale in order to complete a point of sale transaction.

2. The one or more computer-readable media of claim 1, wherein the payment information is stored on a secure element associated with the mobile device.

3. The one or more computer-readable media of claim 1, wherein the payment information comprises a payment account number.

4. The one or more computer-readable media of claim 1, wherein the displayable image comprises one of (i) a barcode image or (ii) a quick response code image.

5. The one or more computer-readable media of claim 1, wherein the computer-executable instructions further configure the one or more processors to:
receive, via a wallet application, a user instruction to generate the displayable image; and
access, by the wallet application in response to the user instruction, the stored payment information in order to generate the displayable image.

6. A merchant point of sale device comprising:
at least one reader device configured to scan an image displayed by a mobile device utilized by a consumer at a point of sale, the image comprising payment information; and
at least one processor configured to (i) receive information associated the scanned image, (ii) process the received information in order to extract the payment information, and (iii) process a payment transaction utilizing the payment information.

7. The merchant point of sale device of claim 6, wherein the at least one reader device comprises an optical scanner.

8. The merchant point of sale device of claim 6, wherein the scanned image comprises one of (i) a barcode image or (ii) a quick response code image.

9. The merchant point of sale device of claim 6, wherein the payment information comprises a payment account number.

10. A computer-implemented method comprising:
storing, in at least one memory associated with a mobile device, payment information;
generating, utilizing the payment information, a displayable image; and
directing output of the image by a display associated with the mobile device, wherein the image is scanned by a reader device at a point of sale in order to complete a point of sale transaction.

11. The computer-implemented method of claim 10, wherein the payment information is stored on a secure element associated with the mobile device.

12. The computer-implemented method of claim 10, wherein the payment information comprises a payment account number.

13. The computer-implemented method of claim 10, wherein the displayable image comprises one of (i) a barcode image or (ii) a quick response code image.

14. The computer-implemented method of claim 10, further comprising:
receive, via a wallet application, a user instruction to generate the displayable image; and
access, by the wallet application in response to the user instruction, the stored payment information in order to generate the displayable image.
